(19) United States
(12) Patent Application Publication
(10) Pub. No.: US 2007/0118407 A1
(43) Pub. Date: May 24, 2007

(54) Medical practitioner's database

(76) Inventor: Roger Dale Glymph, Montgomery, AL (US)

Correspondence Address: Roger D. Glymph, 6397 Eastwood Glen Place, Montgomery, AL, 36117-4710, US

(21) Appl. No.: 11/169,267

(22) Filed: Jun. 23, 2005

(51) Int. Cl. G06F 19/00

(52) U.S. Cl. 705/3

(57) ABSTRACT

This medical database utility design is a unique functional arrangement of all required components of a medical record. The information is converted into a digital format facilitating efficient and versatile usage of pertinent data. All components of the conventional medical chart are designed into a format that greatly enhances the usefulness of medical data used in caring for the patient. It amplifies the value of this medical data by making it easier to comprehend and apply the data collected. Documentation is greatly facilitated with increased accuracy and reproducibility.

This customized medical database was initially designed as a prototype on the non-proprietary version of the Microsoft Access Database. Final design modifications are to be done on the non-proprietary Microsoft Visual Studio Platform using the Microsoft Server Desktop Engine Database. These design modifications will allow much more flexibility with any needed future up-grades of the database design. They also allow for more flexibility in design development as well as a greater ability to design more effective security features. Software design development for the final prototype is well under way. The inventor has contracted a computer software firm capable of developing the utility and design features needed. It is envisioned that the functional prototype for the inventor's medical database will be fully designed and ready for initial testing through my medical practice by the end of 2006. Upon completion of the final prototype, I plan to submit an additional supplemental to this patent application in the form of a prototype CD ROM. A separate patent will also be sought on the newly proposed “Physician's Electronic Data In-put Clip Board.” described in detail in this patent application supplemental.

### REFERENCE TO SEQUENCE LISTING: A LISTING OF TABLES, DESIGNS, AND GRAPHICS

FIG. No. 1 represents the proposed cover page or home page for the medical database utility design. (This figure is unchanged in this supplemental filing.)

FIG. No. 2 represents part 1 of a 3 part design for the Comprehensive History-Physical Database format. (This figure has been modified as shown in the design with a detailed explanation of these changes.)

FIG. No. 3 represents part 2 of the 3 part design for the Comprehensive History-Physical Database format. (This figure has been modified as shown in the design with a detailed explanation of these changes.)

FIG. No. 4 represents part 3 of the 3 part design for the Comprehensive History-Physical Database format. It also illustrates the control databank of tabs that control many of the functions of the entire medical database utility design. (This figure has been modified as shown in the design with a detailed explanation of these changes.)

FIG. No. 4a represents the database overall control bank of functional tabs. (This segment of FIG. No. 4 is unchanged in this supplemental filing.)

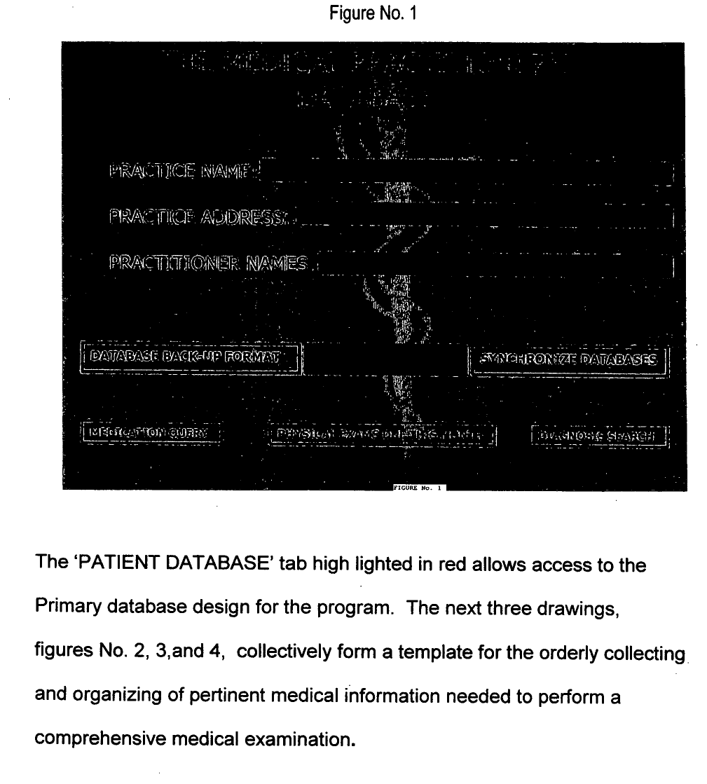

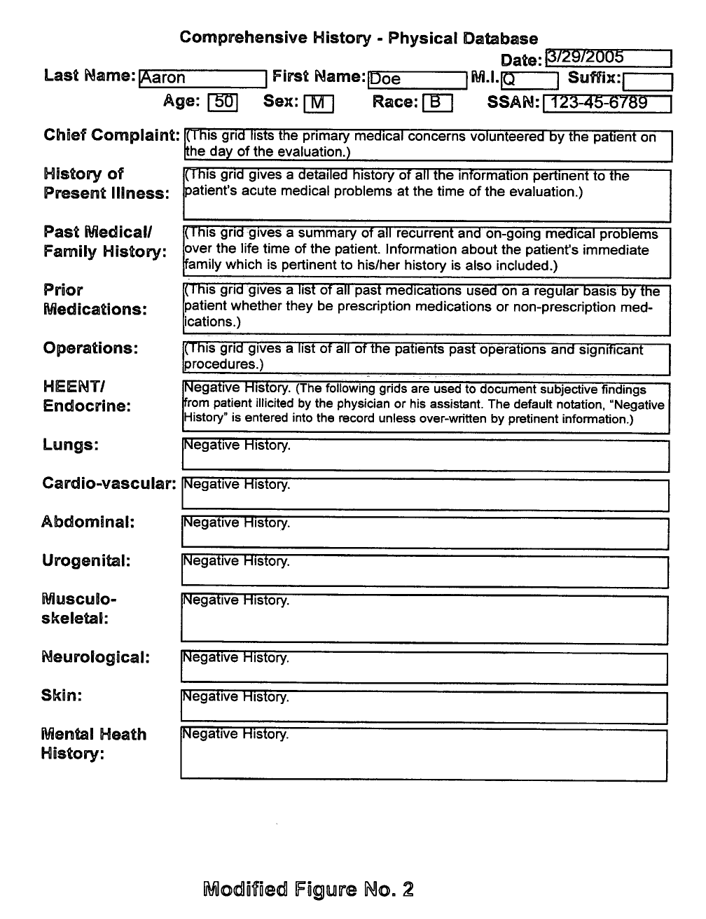

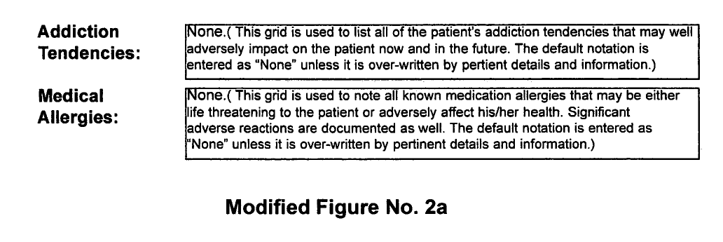

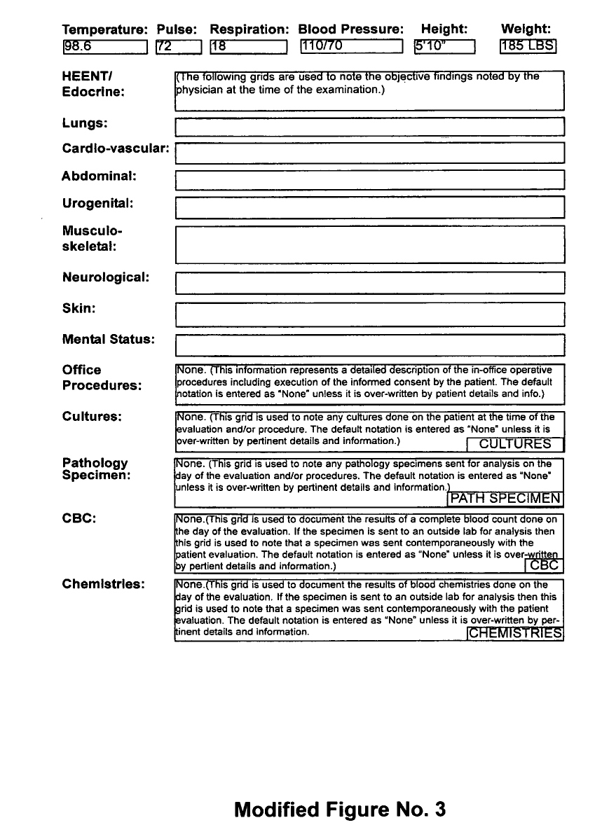

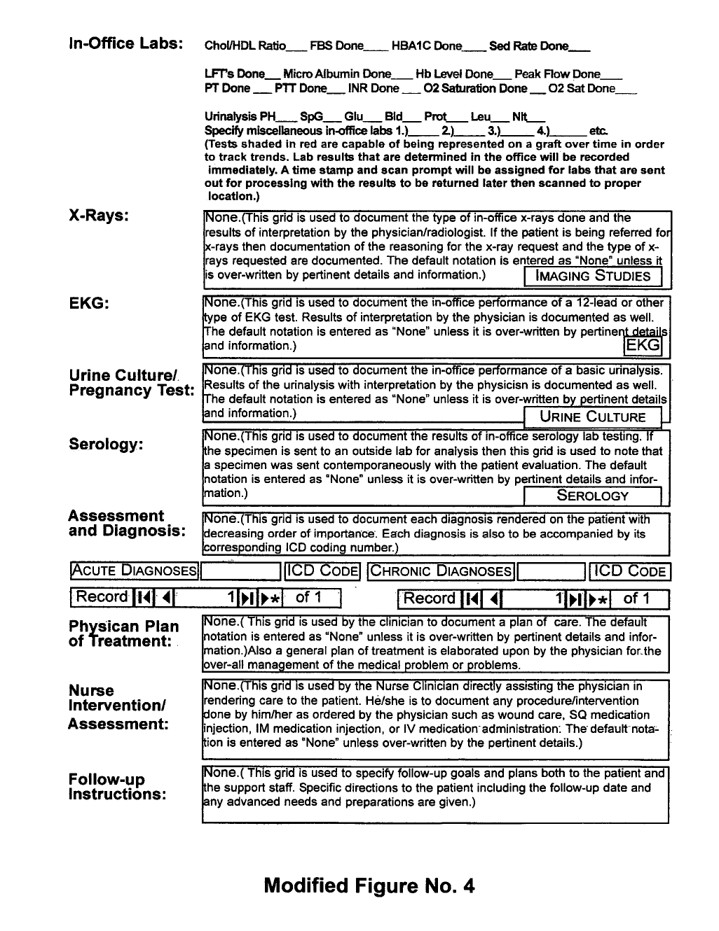

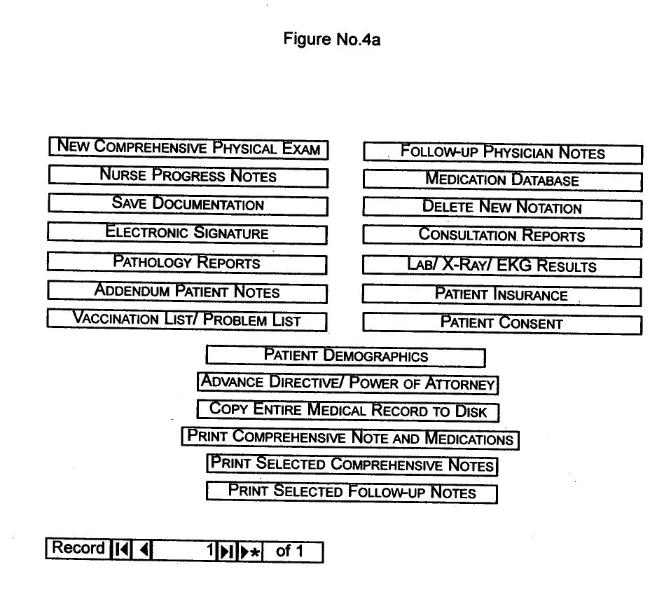

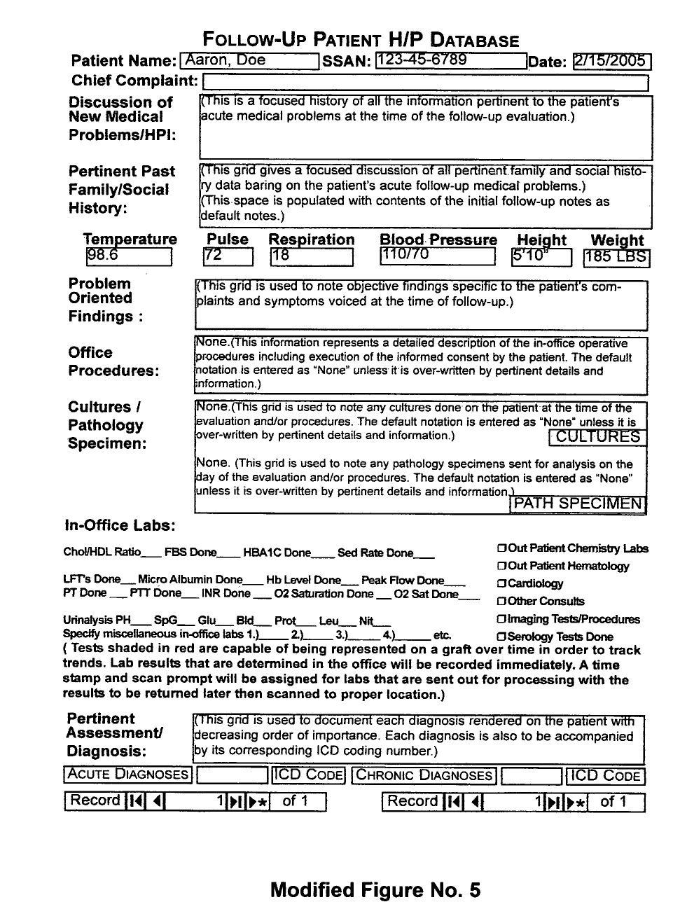

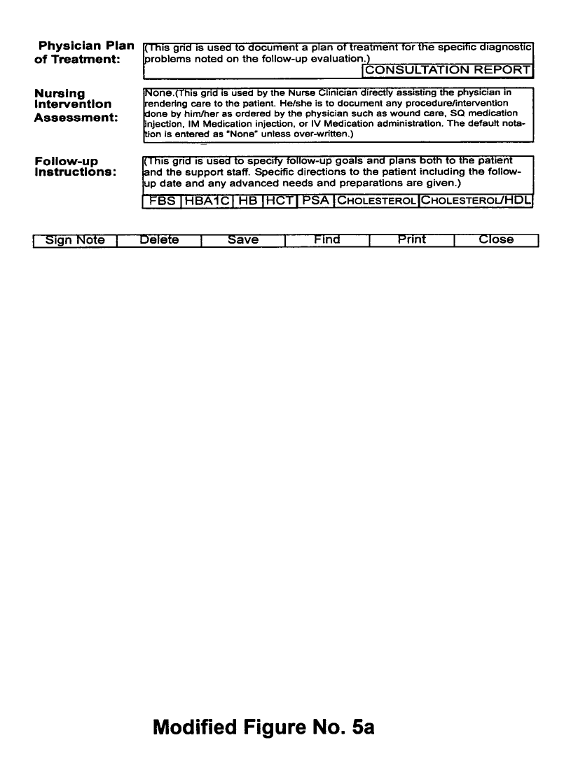

FIG. No. 5 represents the Follow-up Patient H/P Database format. (This figure including FIG. 5a has been modified with a detailed explanation of these changes.)

FIG. No. 6 represents the Nurse Clinician Database used to document services rendered by the Nurse Clinician at the general directions of the physician. (This figure is unchanged in this supplemental filing.)

FIG. No. 7 represents the format used to supplement the above standard documentation databases when needed. (This figure has been modified as shown in the design with a detailed explanation of these changes.)

FIG. No. 8 represents the part of the database to catalog vaccinations/procedures as well as a cumulative list of established diagnoses. (This figure is unchanged in this supplemental filing.)

FIG. No. 9 represents the part of the medical database utility design that catalogs all medications ever prescribed for any particular patient. It has the added capability of being able to generate authentic prescriptions for the patient ready for signature. The medication database also catalogs refills and related comments on medications. (This figure is unchanged from that of the original filing.)

FIG. No. 10 represents the new proposed design for the “Physician's Electronic Data In-put Clip Board” or EDICB. The design, given in three parts, illustrates a device used to facilitate critical data in-put into the appropriate areas of the medical database. It expedites each patient encounter from start to finish in an accurate efficient manner making required documentation by the responsible physician much more timely and coherent.

### DESCRIPTION OF DIFFERENT VIEWS OF DRAWINGS AND SCHEMATICS

FIG. No. 2 modifications are high lighted with the green bordered grids. This green bordering of the data in-put grid indicates that the initial data in-put Into these grids will automatically become the default data for these grids on any subsequent comprehensive history/physical examinations done on this patient in the future. The data described in these grids usually remains the same for the patient in the future. However, this data can be either over written totally or supplemented with additional new data as it becomes available. This feature allows efficient quick documentation of subsequent comprehensive history/physical examinations once the primary information for these girds is obtained on the initial patient evaluation.

FIG. No. 3 similarly has green bordering in the grid used to indicate the patient's height. This data will generally not change once the patient is an adult and past the adolescent growth period. As with the other green shaded grids this data can either be retained or over-written in subsequent comprehensive history/physical examinations. As indicated above this feature allows for accurate documentation while avoiding redundancy of data in-put by the physician.

FIG. No. 4 modifications identify in-office lab tests which are amenable to statistical analysis for clinical trends displayed on graphs. These tests are highlighted in red. The results of these tests are available immediately as apposed to lab specimen being sent out to a reference lab with results to be reported at a later date. These in-office labs are designed to be the subject of statistical analysis. Thus the lab items highlighted in red lend themselves to statistical analysis and form the basis of the patient didactics discussed in the original patent application. This list of in-patient labs may vary among medical practices but most of them are done routinely in most office settings and are quite helpful in determining the effectiveness of clinical patient management.

The results of these in-office labs will be immediately placed into the patient's medical record. They also lend themselves to orderly tabulation and thus statistical analysis over time. Other send-out labs are returned at some later time and in various reporting formats that do not lend themselves to orderly tabulation. The database is designed such that the section of the medical record requiring these lab reports is date and location stamped. When the send-out lab results are returned, the office staff can electronically scan these labs in the proper location allowing coherent and complete documentations including all supporting lab tests, consultations, and procedures.

FIGS. No. 5 and No. 7 above illustrate the supplemental design features for In-house labs highlighted in red and for default data in selected grids bordered in green. Any particular patient needs to have documentation provisions made for both Follow-up Notes, or problem based evaluations, and brief supplemental documentation to the database in the form of Addendum Notes.

In FIG. No. 5 there are two green bordered grids indicating default data which is not subject to change on future evaluations once it is ascertained initially. As stated earlier, the green bordered grids can be over-written totally with entirely new data or they can be supplemented with new information as needed. Both the Follow-up Database format and the Addendum format can include in-office labs. Thus, a section for in-office labs is included in the supplemental design for both of these formats. Provision for the date and location stamp for send-out labs, consults, and procedures is also illustrated to the right of the in-office lab listings.

FIGS. No. 10, 10a, and 10b illustrate the complete design of the newly proposed “Physician's Electronic Data In-put Clip Board” also referred to as the EDICP. This device facilitates the orderly efficient in-put of data into the appropriate fields of the medical database. It also provides for the intake of critical data needed to assign a unique identifier number to each new patient as they are enrolled for the first time by the front office clerical staff. And it generates a lists of all patients treated in the office on a particular day using their assigned ID numbers. One of the particularly time consuming laborious tasks required by the clerical and clinical staff involves continuous phone and/or fax requests for patient prescriptions refills. The EDICP greatly facilitates this on-going task by allowing either the clerical or clinical staff in-put all data required to generate a concise request by each patient in a format that interfaces with the patient's medication database allowing for all noted allergies to be visualized so as not to prescribe any dangerous prohibited medication. Additional pertinent information about the refill request such as the pharmacist's and the patient's call back phone numbers can be placed into the comments section of the refill request. Only information compatible with the medication database format will show up on the refill for newly prescribed medication entry into the patient's medication database. Prior to being actually entered into the medication database the requested prescription is held in abeyance until approved in a quick check off manner by the responsible physician. If the prescription refill request is not approved it remains on the refill list for a predetermined length of time for review. If it is approved then the requested prescription is added to the medication database and simultaneously deleted from the refill call-in list for the day. This un-filled list remains in memory at the close of the work day.

Section No. 10a of the EDICP pertains to the gathering and in-put of initial clinical data on each patient. This initial data in-put is logically done by the clinical staff assisting the responsible physician. Instead of recording pertinent data on loose progress notes the data is placed directly into the database under the guidance of the responsible physician. This prevents needless redundant questioning of the patient and reduces the required documentation of basic data into the medical database by the physician from separate notes. The blue grid border indicates that the grid directly interfaces with a corresponding grid on the chosen format of the medical database. There is a section for both in-office and send-out labs which corresponds to similar sections of the Comprehensive format, the physician Follow-up format, and the Addendum format thus facilitating direct transfer of corresponding data entered on the EDICP. In-office labs are in-put as soon as they are done by the clinical staff using a version of the EDICP or a conventional computer screen which displays features of the EDICP on the screen. Send-out labs are requested in to form of time stamped check-offs by the responsible physician. Then the specimen to be sent for analysis are prepared and sent out by the clinical staff. When results of the requested lab tests, consultations, and procedures are returned to the office then the staff scans them into the appropriate sections of the medical record corresponding to the previously placed time stamp locations.

A critical part of any patient treatment and evaluation has to do with assigning the appropriate accepted diagnosis. All accepted diagnoses are cataloged in a database compiled by the AMA called the International Classification of Diseases or ICD reference. All diagnoses established on the patient must confirm to these diagnostic code guidelines in order to obtain re-imbursement from third party payers such as the patient's medical insurers. The clerical staff can then immediately view these diagnoses and apply appropriate charges for the visit. Within these accepted diagnoses there are chronic, recurrent, and incurable diseases which require proper medical management by the physician over time in order to maintain the patient's health. There are also acute diagnoses which are episodic and can be effectively cured by the physician. Both need to be properly documented but the chronic diseases require more detailed documentation including time of onset, severity, and the degree of treatment response over time through efforts of both the physician and the patient in co-operation. A listing of chronic diseases is provided by the section titled Vaccination History/Problem List illustrated in FIG. No. 8.

The third section of the EDICB has to do with the actual formulation of a treatment plan by the responsible physician and then relaying this plan to his clinical staff in the form of directives. These ideas can be formulated and simultaneously entered directly into the database in the field titled Physician Plan of Treatment. Then the Nurse or Medical Assistant can carry out these directives immediately while documenting their actions in the field titled Nursing Intervention/Assessment. Note that these field are reversed from their order in the original patent filing. Finally, the Physician can give the patient directions on the use of medications and/or other treatment to be carried out at home. He also indicates a time of requested follow-up with the patient and any future planned labs, consults, and procedures to be done at that time. Then the front-office clerical staff can use this information to issue the patient a follow-up appointment with required follow-up instructions. The illustration below gives the design for the third and final section of the EDICB.

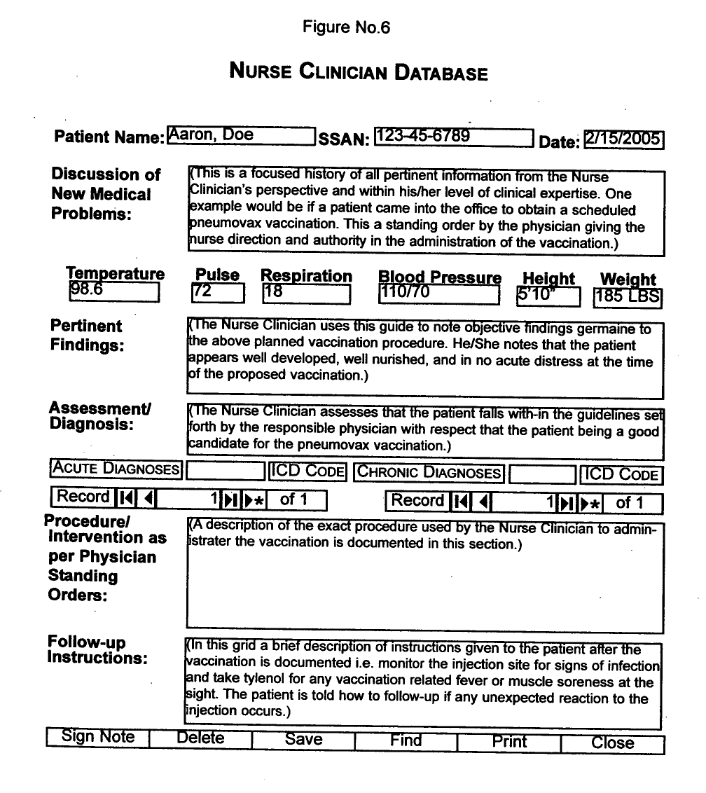

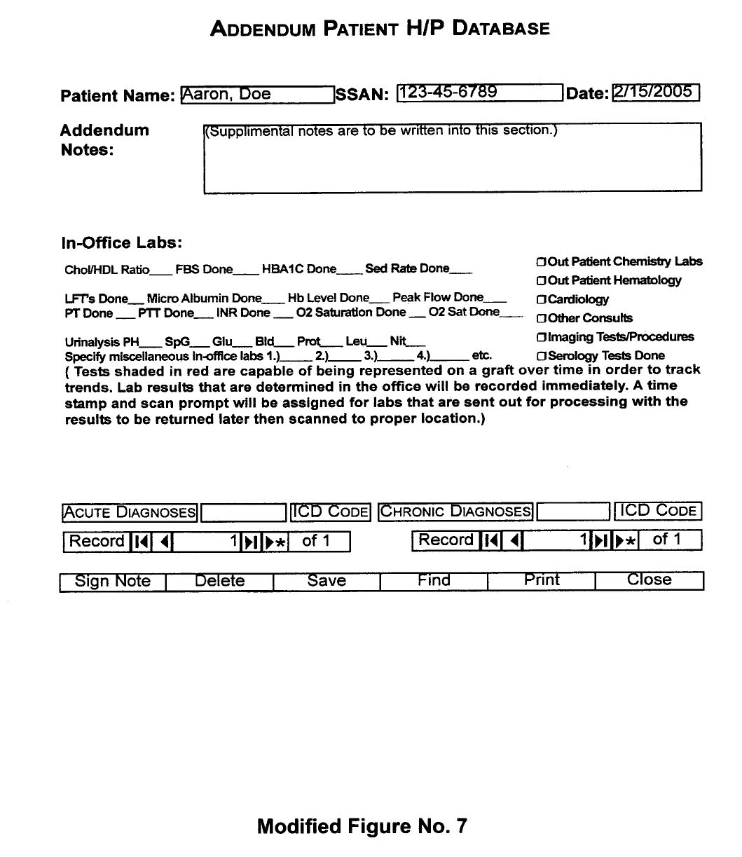

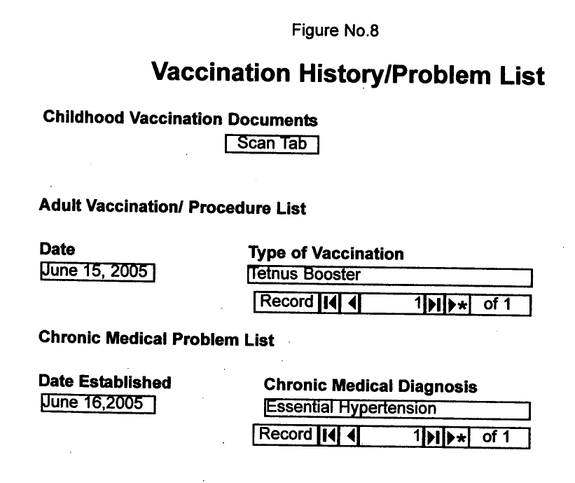

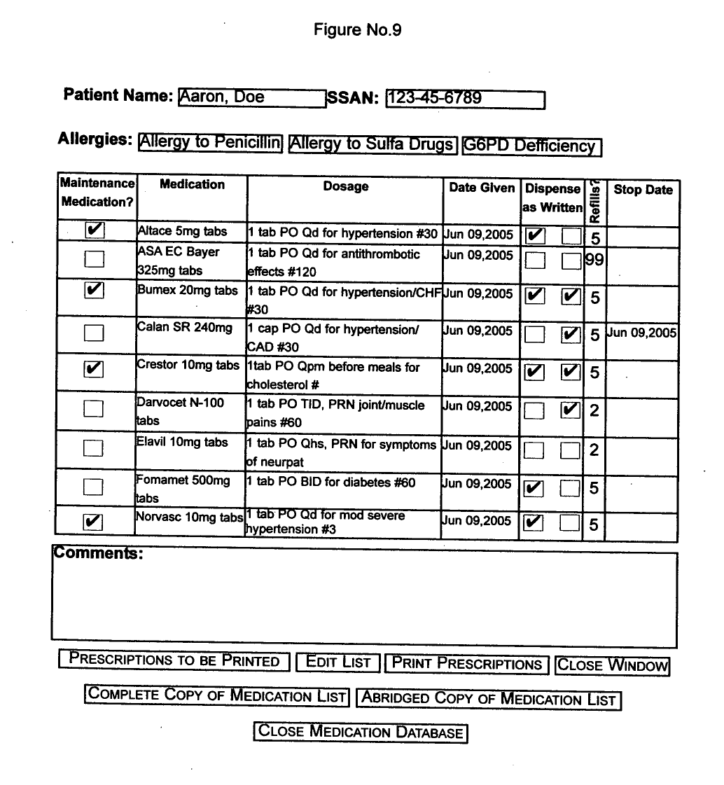

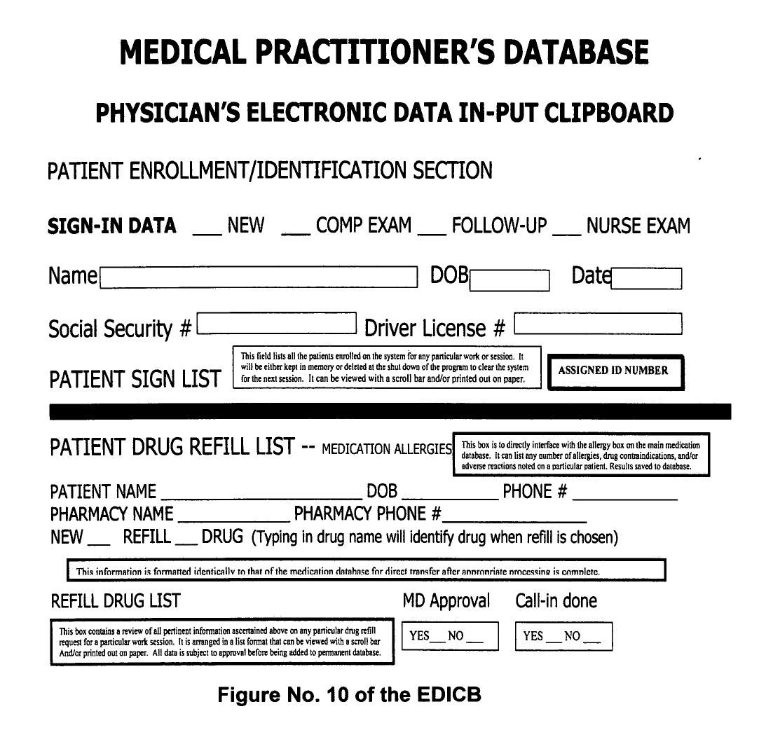

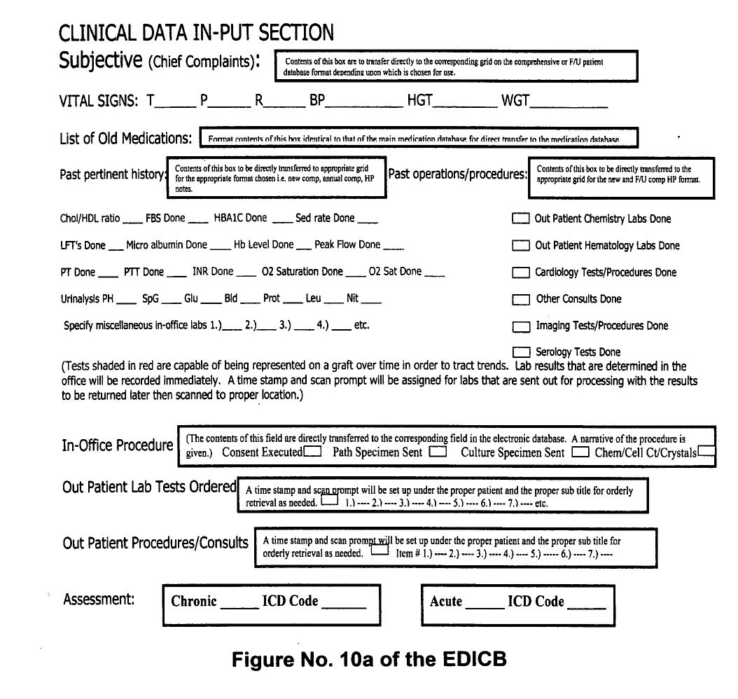

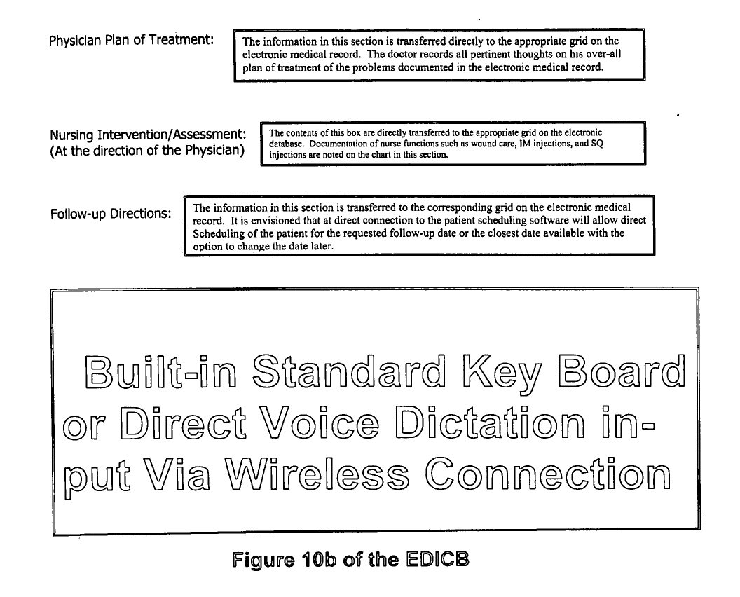

It is labeled FIG. 10b. Note that the bottom part of this section to the EDICB contains a space for building-in a computer key board. This built-in key board allows the EDICB to be more self contained or portable. It is envisioned that the EDICB will have built-in capabilities allowing voice dictation via a wireless microphone. The EDICB itself would also have a wireless secured connection to the office computer network or server.

1. This invention is a custom medical design format that greatly facilitates medical record documentation. A utility and design patent is being sought for this organizational design template providing for the unique digital creation of a complete medical record. Data in-put and utilization of the medical database is made much more efficient. The uniqueness of the design for this program pertains to the special arrangement of all the required components of the standard medical record compatible with a digital format.
This special arrangement allows the development of a unique digital software program flexible enough to encompass the needs of any general medical practice. A key feature of the design allows the generation of authentic prescriptions while simultaneously entering and editing prescription details into a medication database. The over all database also has basic research capability incorporated into the design. The unique utility feature of this design format is its ability to greatly facilitate the requirements of medical documentation both accurately and consistently. The system is also able to qualitatively characterize patient data through specific queries, charts, and graphs. This unique design emphasizes practical function, speed, and ease of use, with medico-legally sound and accurate reproduction.
